(19) United States
(12) Patent Application Publication
(10) Pub. No.: US 2002/0104240 A1
(43) Pub. Date: Aug. 8, 2002

(54) Product labelling

(75) Inventors: Steven Howell, Northamptonshire (GB); Martin Vincent Jones, Merseyside (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/067,664

(22) Filed: Feb. 5, 2002

(30) Foreign Application Priority Data
Feb. 6, 2001 (GB) 0102933.9

(51) Int. Cl. G09F 19/14; B65D 85/00

(52) U.S. Cl. 40/453; 206/459.5; 206/459.1

(57) ABSTRACT

An article of commerce comprising a product having an outer label and/or packaging bearing a hologram, the hologram depicting a first image when viewed from one angle and a second image when viewed from a second angle, the first image depicting a problem or task associated with the use of the product and the second image depicting the effect of using the product.

### FIELD OF THE INVENTION

This invention relates to product labelling and in particular to products bearing a label comprising a hologram and to products contained within a package which bears a hologram on its outer surface.

### BACKGROUND TO THE INVENTION

The use of holograms in association with products is known. Holograms have been used for security purposes in connection with bank notes, credit cards etc., as tamper evident or authenticity seals and labels as disclosed for example in EP 543040, EP 673853, EP847931, WO91/18377, WO96/27178, WO98/15939, JP-08054818, FR2689670, GB2331505, DE2962074, CN1090074 and U.S. Pat. No. 3,797,492. Holograms have also been used for decorative packaging purposes as disclosed, for example, in JP09226770, JP08185122, U.S. Pat. No. 5,775,057 and WO99/43570.

U.S. Pat. No. 6,044,970 discloses a package for a golf instrument which comprises a label in the form of a hologram which displays the contents and quality of the golf instrument. For example, the package may be a golf ball box and the holographic display may comprise a first image displaying the external view of a golf ball and, when viewed from a different angle, a second image displaying the internal structure of the golf ball.

When displaying products for consumer purchase it is important that the consumer is aware of the use and function of the product. This may readily be achieved in the form of text on the packaging or label of the product but this will only be understood by a literate consumer is who is familiar with the language of the text. In addition packaging may bear graphic information showing the use of the product but this may not always be possible if there is insufficient surface area on the package or label area on the product.

The invention has been made with the above points in mind.

### SUMMARY OF THE INVENTION

According to the invention there is provided an article of commerce comprising a product having an outer label and/or packaging bearing a hologram, the hologram depicting a first image when viewed from one angle and a second image when viewed from a second angle, the first image depicting a problem or task associated with the use of the product and the second image depicting the effect of using the product. Also according to the invention there is provided an article to identify its function which comprises securing to the outer surface of the article and to its associated packaging a hologram, the hologram depicting a first image when viewed from one angle and a second image when viewed from a second angle, the first image depicting a problem or task associated with the use of the product and the second image depicting the effect of using the product.

The invention provides a simple, effective and attractive method of displaying information about the product on the outer surface of the product or its associated packaging. The information is in graphic or pictorial form thereby overcoming any potential literary or language problems. The hologram effectively uses the same labelling or packaging area to be used twice since each of the two images occupies the same area thereby enabling large clear images to be provided. Furthermore, the use of a hologram allows attractive iridescent, three-dimensional images to be displayed.

The production of holograms is well known and the holograms used in the subject invention may be prepared by any of the known techniques. The holograms may be applied as a label directly to the product e.g. the outside of a container and/or the hologram may be present on the outer surface of any associated packaging.

The product may be selected from a wide range of products including products for industrial or office use and household consumable products. Examples of products include laundry products, household cleaners, toothpaste, cosmetics, hair care products, insecticides, biocides, disinfectants, air fresheners, diagnostic products, foods, over the counter medicines and pet products.

The first image of the hologram graphically or pictorially depicts a problem or task associated with the use of the product. Numerous consumer problems may be graphically depicted including:

a) stained clothing or dull clothing for wash powders

b) flies and insects for insect killing products

c) sweaty body parts for anti-perspirant product

d) malodour for deodorant product

e) dirty work surfaces or dirty toilets, baths etc. for cleaners

f) tooth decay for toothpaste

g) tangled/dirty hair for shampoos etc.

h) wrinkled skin for skin cream

i) unhealthy area or part of the body

The second image depicts the effect of the product in solving the consumer problem e.g.

a) clean clothes

b) dead flies

c ) dry body parts

d) pleasant body odour

e) clean toilets/surface

f) healthy teeth

g) healthy hair

h) rejuvenated skin

i) rejuvenated body part

The first image may depict the need to know information by, for example, a question mark and would be used for diagnostic products. In this case, the second image would represent the test the diagnostic performs, for example in the case of a pregnancy test a picture of a baby could depict this.

The product may contain additional holograms providing graphic or pictorial information on how the product should be used.

Multiple images are particularly relevant where a product is used at different dosages or dilutions and it is important that the user is simply and clearly advised of the correct dose for the particular purpose. Examples would include a household cleaner which is used neat for spot cleaning on surfaces but diluted into a bucket for washing large surfaces such as floors or a cough medicine which is dosed at two spoonfuls for adults but only one spoonful for children. Such information is conveyed clearly and quickly by the use of two or more hologram images.

### DESCRIPTION OF THE PREFERRED EMBODIMENTS

The invention will now be described with reference to the accompanying drawings in which:

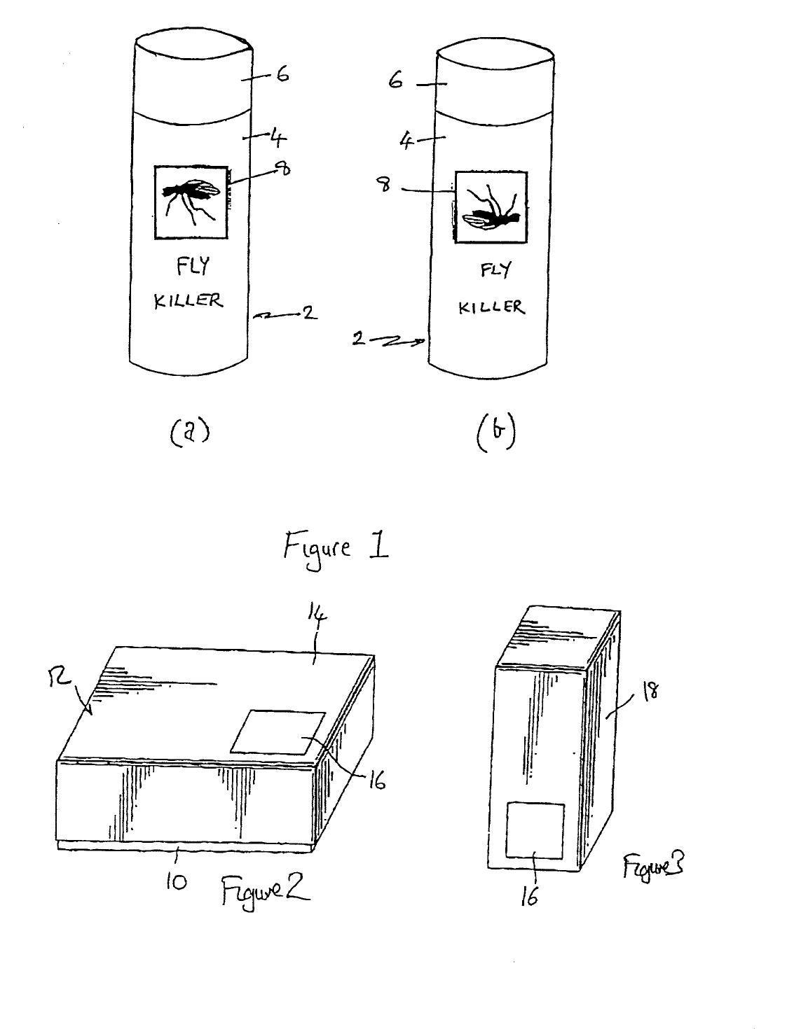

FIG. 1(a) represents a product in accordance with the invention bearing a label comprising a hologram showing a first image,

FIG. 1(b) represents the product of FIG. 1(a) showing a second image of the hologram,

FIG. 2 represents a package in accordance with the invention and

FIG. 3 represents a further package in accordance with the invention.

FIGS. 1(a) and 1(b) show a product (2) which is in the form of a canister (4) having a lid (6). In this particular example the product (2) is a fly spray which may be a pressurised aerosol, a powder dispensing device or a pump action spray etc. The canister (4) bears a label (8) comprising a hologram.

In the label shown in FIG. 1(a) the image of the hologram depicts a living fly indicating that the problem associated with the product is flies and insects. In the label shown in FIG. 1(b) the hologram is viewed from a different angle to depict a second image which shows a dead fly thereby indicating the function of the product is a fly killer. FIGS. 2 and 3 show packaging in accordance with the invention. FIG. 2 shows a box comprising a base (10) and a lid (12), the upper surface (14) of the lid comprising a hologram (16). FIG. 3 shows a sealed package (18) bearing a hologram (16).

1. An article of commerce comprising a product having an outer label and/or packaging bearing a hologram, the hologram depicting a first image when viewed from one angle and a second image when viewed from a second angle, the first image depicting a problem or task associated with the use of the product and the second image depicting the effect of using the product.

2. An article as claimed in claim 1 in which said hologram is present on a label affixed directly to the article.

3. An article as claimed in claim 1 or claim 2 in which said hologram is present on the outer surface of a package within which the product is contained.

4. An article as claimed in claim 1 in which the first and second images are pictorial or graphic.

5. An article as claimed in claim 1 in which the product is a household consumable product.

6. An article as claimed in claim 5 in which the product is selected from laundry products, household cleaners, toothpaste, cosmetics, hair care products, insecticides, biocides, disinfectants, air fresheners, diagnostic products, foods, over the counter medicines and pet products.

7. An article as claimed in claim 1 substantially as herein described with reference to the accompanying drawings.

8. A method of packaging an article to identify its function which comprises securing to the outer surface of the article and to its associated packaging a hologram, the hologram depicting a first image when viewed from one angle and a second image when viewed from a second angle, the first image depicting a problem or task associated with the use of the product and the second image depicting the effect of using the product.

9. A method as claimed in claim 8 in which said hologram is present on a label affixed directly to the article.

10. A method as claimed in claim 8 or claim 9 in which said hologram is present on the outer surface of a package within which the product is contained.

11. A method as claimed in claims 8 to 10 in which the first and second images are pictorial or graphic.

12. A method as claimed in claims 8 to 11 in which the product is a household consumable product.

13. A method as claimed in claim 12 in which the product is selected from laundry products, household cleaners, toothpaste, cosmetics, hair care products, insecticides, biocides, disinfectants, air fresheners, diagnostic products, foods, over the counter medicines and pet products.

14. A method as claimed in claim 8 substantially as herein described with reference to the accompanying drawings.
